(19) United States
(12) Patent Application Publication
(10) Pub. No.: US 2012/0019376 A1
(43) Pub. Date: Jan. 26, 2012

(54) UTILITY VEHICLE WITH PARKING BRAKE WARNING SOUND GENERATOR

(75) Inventors: Byoung Soo KWON, Changnyeong-gun (KR); Seung Su LEE, Changnyeong-gun (KR)

(73) Assignees: HANKUK CHAIN INDUSTRIAL CO., LTD., Anseong-si (KR); DAEDONG INDUSTRIAL CO., LTD., Daegu (KR)

(21) Appl. No.: 13/186,819

(22) Filed: Jul. 20, 2011

(30) Foreign Application Priority Data
Jul. 23, 2010 (KR) 10-2010-0071232

(51) Int. Cl. B60Q 5/00

(52) U.S. Cl. 340/457.3

(57) ABSTRACT

A utility vehicle equipped with a parking brake is provided, which includes a parking brake warning sound generator immediately operated when the vehicle is driven while the parking brake is engaged. A parking brake warning sound generator is provided, which includes a parking brake detector detecting whether a parking brake is engaged; a drive detector detecting whether the vehicle is driven; a controller for receiving a signal from the parking brake detector and a signal from the drive detector to determine whether the vehicle is driven while the parking brake is being engaged; and a warning sound generator receiving the determination result from the controller to emit a warning sound for warning the driver that the vehicle is driven while the parking brake is being engaged. The parking brake warning sound generator emits a warning sound when a vehicle drive signal is detected while the parking brake is engaged.

### CROSS-REFERENCE TO RELATED APPLICATION

This application claims priority to and the benefit of Korean Patent Application No. 10-2010-0071232, filed on Jul. 23, 2010, the disclosure of which is incorporated herein by reference in its entirety.

### BACKGROUND

1. Field of the Invention

The present invention relates to a utility vehicle and, more particularly, to a utility vehicle with a parking brake warning sound generator, which can draw a driver's attention through a warning sound generator installed in front of the driver's seat when the vehicle is driven while a parking brake is engaged.

2. Discussion of Related Art

In general, utility vehicles are used to transport goods and people in working environments where ordinary vehicles are difficult to enter or operate such as unpaved roads or mountains passes.

FIG. 1 is a schematic diagram showing a conventional utility vehicle, and FIG. 2 is an enlarged view of portion-A in FIG. 1. As shown in the figures, the conventional utility vehicle has a structure in which a driver's seat 10 and a cargo box 20 are exposed to the outside, and the driver's seat 10 is covered by a rollover protective frame 30 for preventing damage to the driver during vehicle rollover.

The rollover protective frame 30 is fixedly supported by a main frame that forms the frame of the vehicle.

In the main frame, an engine room 60 is formed in a space at the bottom of the cargo box 20 at the rear of the driver's seat 10 and a radiator room 70 is formed in a space in front of the driver's seat 10.

Moreover, the utility vehicle is equipped with a foot brake and a parking brake as brake systems.

The foot brake is used as a main brake system of the vehicle and serves to decelerate or stop the vehicle when the driver depresses the brake pedal with his or her foot.

The parking brake is used as an auxiliary brake system and servers to brake wheels while the vehicle is stopped, thus preventing the movement of the vehicle parked or stopped. The parking brake is also called a handbrake or side brake.

FIGS. 1 and 2 show an example of a parking brake lever 80 mounted on the left side of the driver's seat 10.

When the vehicle is parked or stopped, the driver typically pulls the parking brake lever 80 to set the brake state and then leaves the vehicle. Then, the driver releases the parking brake lever 80 to release the brake state and drive the vehicle.

However, the vehicle may be driven while the parking brake lever 80 is being engaged due to the driver's carelessness, which mainly occurs when the driver does not have much experience in driving the vehicle. If the vehicle is driven while the parking brake lever 80 is being engaged, considerable wear and tear occurs on a brake lining or pad to reduce the durability of the brake system. Moreover, the brake system cannot perform its normal functions due to thermal deformation and rupture of the brake lining or pad, which needs to be replaced with a new one.

Especially, when a fire breaks out due to overheating of the brake system, the vehicle may be completely destroyed by the fire or the driver may be damaged.

For these reasons, a warning light for warning the operating state of the parking brake is to be mounted on a dashboard of the vehicle. The warning light is turned on and off when the parking brake is operated, thereby drawing the driver's attention.

However, as the parking brake warning light is mixed with other warning lights on the dashboard, it is confused with other warning lights or not noticeable. Especially, when the sunlight is incident on a transparent window of the dashboard, the parking brake warning light is more unnoticeable.

### SUMMARY OF THE INVENTION

The prevent invention has been made in an effort to solve the above-described problems associated with the prior art, and an object of the present invention is to provide a parking brake warning sound generator for a utility vehicle, which emits a warning sound when a vehicle drive signal is detected while a parking brake is engaged, thereby drawing a driver's attention.

Moreover, another object of the present invention is to provide a parking brake warning sound generator for a utility vehicle, which is installed on a relay bracket in front of the driver's seat, which facilitates the installation and maintenance and makes it possible for the driver to quickly cope with the current situation.

According to an aspect of the present invention for achieving the above objects, there is provided a utility vehicle equipped with a parking brake, the vehicle comprising a parking brake warning sound generator, which is immediately operated, when the vehicle is driven while the parking brake is engaged, to draw a driver's attention.

According to another aspect of the present invention for achieving the above objects, there is provided a utility vehicle with a parking brake warning sound generator comprising: a parking brake detector for detecting whether a parking brake is engaged; a drive detector for detecting whether the vehicle is driven; a controller for receiving a signal from the parking brake detector and a signal from the drive detector to determine whether the vehicle is driven while the parking brake is being engaged; and a warning sound generator for receiving the determination result from the controller to emit a warning sound for warning the driver that the vehicle is driven while the parking brake is being engaged.

The warning sound generator may be installed in front of the driver's seat.

The warning sound generator may be installed on a relay bracket in a radiator room in front of the driver's seat.

The utility vehicle of the present invention may further comprise a cargo box for loading cargoes, provided at the rear of a driver's seat, an engine room for generating vehicle driving power, provided at the bottom of the driver's seat, and a radiator room for cooling the engine room, provided in front of the driver's seat.

The utility vehicle of the present invention may further comprise a parking brake lever mounted on the left side of the driver's seat.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic diagram showing a conventional utility vehicle;

FIG. 2 is an enlarged view of portion-A in FIG. 1;

FIG. 3 is a schematic diagram showing a utility vehicle equipped with a parking brake warning sound generator in accordance with the present invention;

FIG. 4 is a conceptual diagram showing the operation principle of the parking brake warning sound generator in accordance with the present invention;

FIG. 5 is a side view showing a portion where the warning sound generator in accordance with the present invention is mounted; and

FIG. 6 is a front view showing the portion where the warning sound generator in accordance with the present invention is mounted.

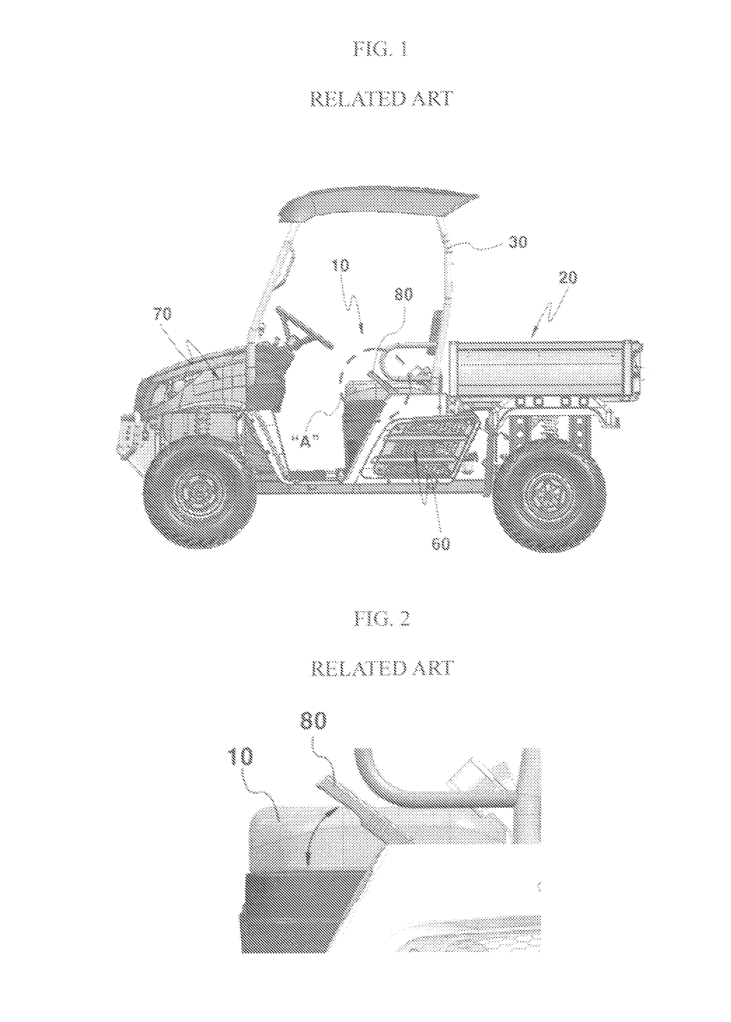

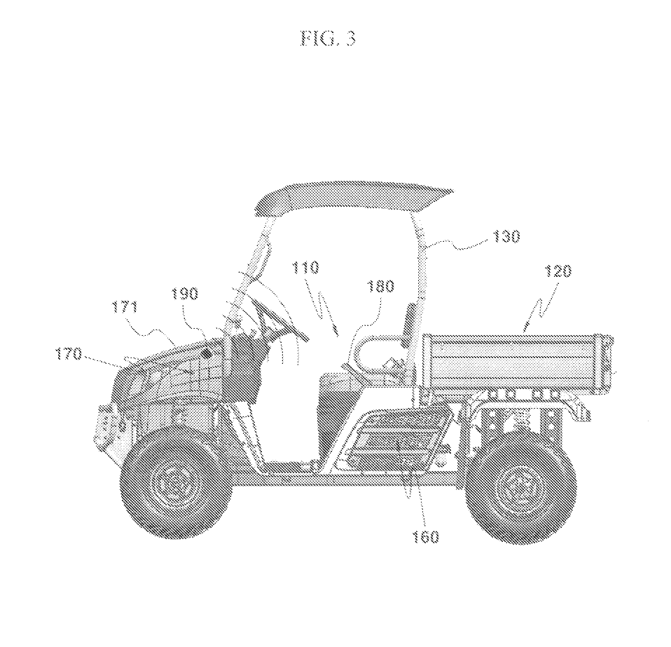

### DETAILED DESCRIPTION OF EXEMPLARY EMBODIMENTS

Hereinafter, exemplary embodiments of the present invention will be described in detail below with reference to the accompanying drawings such that those skilled in the art to which the present invention pertains can easily practice the present invention.

FIG. 3 is a schematic diagram showing a utility vehicle equipped with a parking brake warning sound generator in accordance with the present invention. In the utility vehicle as shown in FIG. 3, a cargo box 120 for loading cargoes is provided at the rear of a driver's seat 110, an engine room 160 for generating vehicle driving power is provided at the bottom of the driver's seat 110, and a radiator room 170 for cooling the engine room 160 is provided in front of the driver's seat 110.

Here, the cargo box 120 and the driver's seat 110 may be exposed to the outside, and thus the driver's seat 110 is covered by a rollover protective frame 130 for preventing damage to the driver during vehicle rollover.

In the utility vehicle of the present invention, a parking brake as an auxiliary brake system is further provided in addition to a foot brake used as a main brake system.

As shown in FIG. 3, the parking brake can be controlled by manually operating a parking brake lever 180 mounted on the left side of the driver's seat 110.

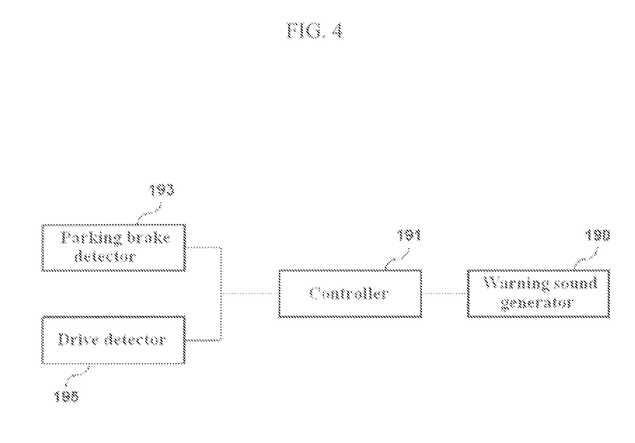

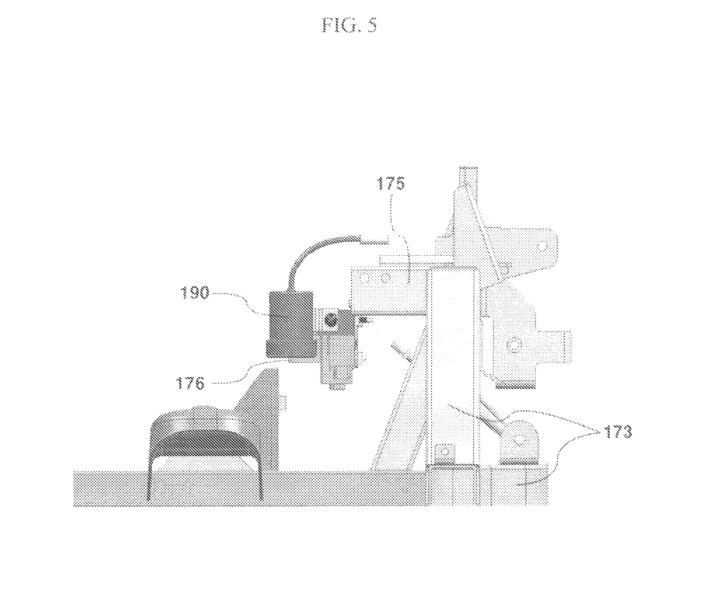

An operation signal of the parking brake lever 180 may be detected by a parking brake detector 193 as shown in FIG. 4.

FIG. 4 is a conceptual diagram showing the operation principle of the parking brake warning sound generator in accordance with the present invention and, as shown in the figure, the signal input through the parking brake detector 193 is transmitted to a controller 191.

Here, the controller 191 receives a signal from a drive detector 195 together with the signal from the parking brake detector 193 to determine whether the parking brake is engaged and, if the parking brake is engaged, transmits a signal to a warning sound generator 190 to generate a warning sound, thereby drawing the driver's attention.

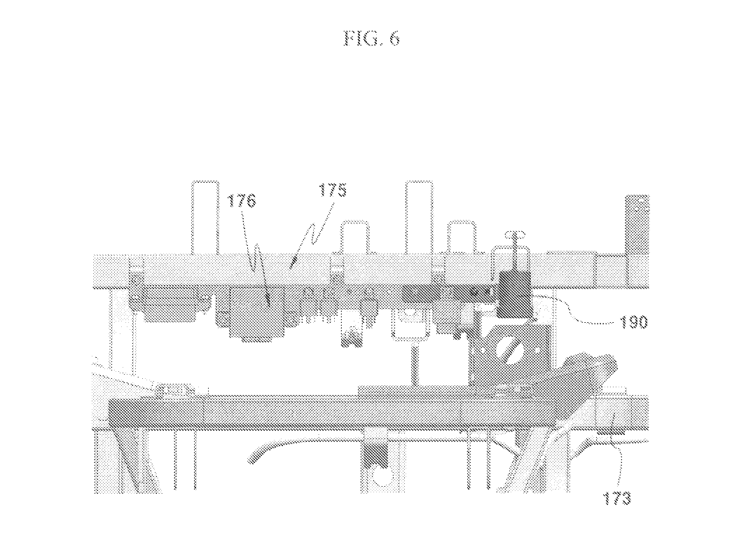

The warning sound generator 190 may be mounted in front of the driver's seat 110 as shown in FIG. 3, which will be described in more detail with reference to FIGS. 5 and 6 below.

FIG. 5 is a side view showing a portion where the warning sound generator in accordance with the present invention is mounted, and FIG. 6 is a front view showing the portion where the warning sound generator in accordance with the present invention is mounted.

When the radiator room 170 formed in front of the driver's seat 110 is opened by opening a bonnet 171, a relay bracket 175 is positioned at the top of a vehicle body frame 173, adjacent to the driver's seat 110.

The relay bracket 175 is used to as a structure for mounting a fuse box and a relay box 176 for controlling electric circuit signals in the vehicle.

In the present invention, the warning sound generator 190 is mounted on the relay bracket 175.

The warning sound generator 190 may be a loudspeaker or horn.

Suitably, the warning sound generator 190 may be installed on one side of the relay box 176 positioned in front of the driver.

The warning sound generator 190 receives a signal from the controller 191. That is, when it is determined that the parking brake is engaged and the vehicle is currently driving, the controller 191 emits a warning sound such that the driver can quickly cope with the current situation.

As described above, the present invention provides the parking brake warning sound generator for the utility vehicle, which emits a warning sound when a vehicle drive signal is detected while the parking brake is engaged, thereby drawing the driver's attention. As a result, the drive can quickly cope with the current situation to prevent wear and tear of the parking brake and peripheral components, thereby preventing a safety accident.

Moreover, since the parking brake warning sound generator of the present invention is installed on the relay bracket in front of the driver's seat, the installation and maintenance of the parking brake warning sound generator is facilitated, and since the position of the parking brake warning sound generator installed in the vehicle is closest to the driver, the driver can quickly cope with the current situation.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A utility vehicle equipped with a parking brake, the vehicle comprising a parking brake warning sound generator, which is immediately operated, when the vehicle is driven while the parking brake is engaged, to draw a driver's attention.

2. A utility vehicle with a parking brake warning sound generator comprising:
a parking brake detector for detecting whether a parking brake is engaged;
a drive detector for detecting whether the vehicle is driven;
a controller for receiving a signal from the parking brake detector and a signal from the drive detector to determine whether the vehicle is driven while the parking brake is being engaged; and
a warning sound generator for receiving the determination result from the controller to emit a warning sound for warning the driver that the vehicle is driven while the parking brake is being engaged.

3. The utility vehicle of claim I, wherein the warning sound generator is installed in front of the driver's seat.

4. The utility vehicle of claim 3, wherein the warning sound generator is installed on a relay bracket in a radiator room in front of the driver's seat.

5. The utility vehicle of claim I, further comprising a cargo box for loading cargoes, provided at the rear of a driver's seat, an engine room for generating vehicle driving power, provided at the bottom of the driver's seat, and a radiator room for cooling the engine room, provided in front of the driver's seat.

6. The utility vehicle of claim 5, further comprising a parking brake lever mounted on the left side of the driver's seat.

7. The utility vehicle of claim 2, wherein the warning sound generator is installed in front of the driver's seat.

8. The utility vehicle of claim 7, wherein the warning sound generator is installed on a relay bracket in a radiator room in front of the driver's seat.

9. The utility vehicle of claim 2, further comprising a cargo box for loading cargoes, provided at the rear of a driver's seat, an engine room for generating vehicle driving power, provided at the bottom of the driver's seat, and a radiator room for cooling the engine room, provided in front of the driver's seat.

10. The utility vehicle of claim 9, further comprising a parking brake lever mounted on the left side of the driver's seat.
